(19) United States
(12) Patent Application Publication
(10) Pub. No.: US 2016/0142711 A1
(43) Pub. Date: May 19, 2016

(54) VIDEO CODER WITH ADAPTIVE BAC ENGINE AND METHODS FOR USE THEREWITH

(71) Applicant: ViXS SYSTEMS, INC., Toronto (CA)

(72) Inventors: Ying Li, Richmond Hill (CA); Dong Liu, Markham (CA); Xu Gang Zhao, Maple (CA)

(73) Assignee: ViXS SYSTEMS, INC., Toronto (CA)

(21) Appl. No.: 14/861,537

(22) Filed: Sep. 22, 2015

Related U.S. Application Data
(60) Provisional application No. 62/080,808, filed on Nov. 17, 2014.

(51) Int. Cl. H04N 19/13; H04N 19/103; H04N 19/65

(52) U.S. Cl. CPC H04N 19/13; H04N 19/65; H04N 19/103

(57) ABSTRACT

Aspects of the subject disclosure may include, for example, a binary arithmetic coding engine that includes a lossy binary arithmetic coding module configured to process input data into lossy binary arithmetic coded data when a mode selection signal indicates a first mode of operation. A lossless binary arithmetic coding module processes the input data into lossless binary arithmetic coded data when the mode selection signal indicates a second mode of operation. Other embodiments are disclosed.

### CROSS REFERENCE TO RELATED APPLICATIONS

The present U.S. Utility patent application claims priority pursuant to 35 U.S.C. §119(e) to U.S. Provisional Application No. 62/080,808, entitled “VIDEO CODER WITH ADAPTIVE BAC ENGINE AND METHODS FOR USE THEREWITH”, filed Nov. 17, 2014, which is hereby incorporated herein by reference in its entirety and made part of the present U.S. Utility patent application for all purposes.

### TECHNICAL FIELD OF THE DISCLOSURE

The present disclosure relates to entropy decoding and quantization used in devices such as video codecs.

### DESCRIPTION OF RELATED ART

Video encoding has become an important issue for modern video processing devices. Robust encoding algorithms allow video signals to be transmitted with reduced bandwidth and stored in less memory. However, the accuracy of these encoding methods face the scrutiny of users that are becoming accustomed to greater resolution and higher picture quality. Standards have been promulgated for many encoding methods including the H.264 standard that is also referred to as MPEG-4, part 10 or Advanced Video Coding, (AVC).

Binary arithmetic coding (BAC) is a type of coding included in H.264, H.265 and other video encoding standards. While BAC is only a small part of encoding and decoding, BAC processing can have a great effect on processing time due to the large number of times BAC calculations are performed in processing a single picture. Faster BAC processing can, in many circumstances, lead to faster video decoding.

Further limitations and disadvantages of conventional and traditional approaches will become apparent to one of ordinary skill in the art through comparison of such systems with the present disclosure.

### BRIEF DESCRIPTION OF THE SEVERAL VIEWS OF THE DRAWINGS

FIGS. 1-3 present pictorial diagram representations of various devices in accordance with embodiments of the present disclosure.

FIG. 4 presents a block diagram representation of a video processing device in accordance with an embodiment of the present disclosure.

FIG. 5 presents a block diagram representation of a video encoder/decoder 102 in accordance with an embodiment of the present disclosure.

FIG. 6 presents a block flow diagram of a video encoding operation in accordance with an embodiment of the present disclosure.

FIG. 7 presents a block flow diagram of a video decoding operation in accordance with an embodiment of the present disclosure.

FIG. 8 presents a block diagram representation of a binary arithmetic coding engine 201 in accordance with an embodiment of the present disclosure.

FIG. 9 presents a block diagram representation of a rate distortion optimized quantization module 221 in accordance with an embodiment of the present disclosure.

FIG. 10 presents a block diagram representation of a video distribution system 375 in accordance with an embodiment of the present disclosure.

FIG. 11 presents a block diagram representation of a video storage system 179 in accordance with an embodiment of the present disclosure.

FIG. 12 presents a flowchart representation of a method in accordance with an embodiment of the present disclosure.

FIG. 13 presents a flowchart representation of a method in accordance with an embodiment of the present disclosure.

### DETAILED DESCRIPTION OF THE DISCLOSURE INCLUDING THE PRESENTLY PREFERRED EMBODIMENTS

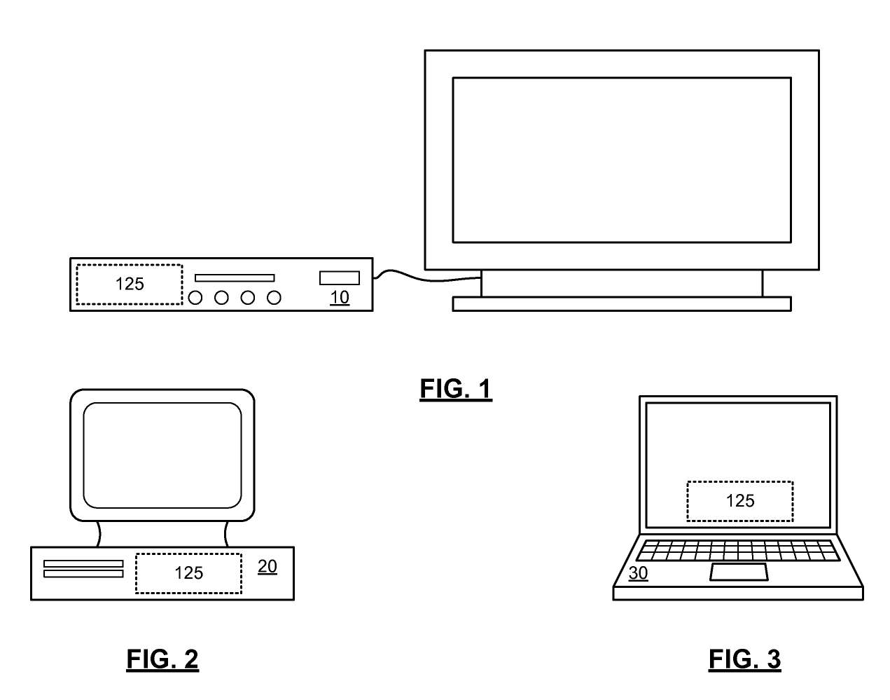

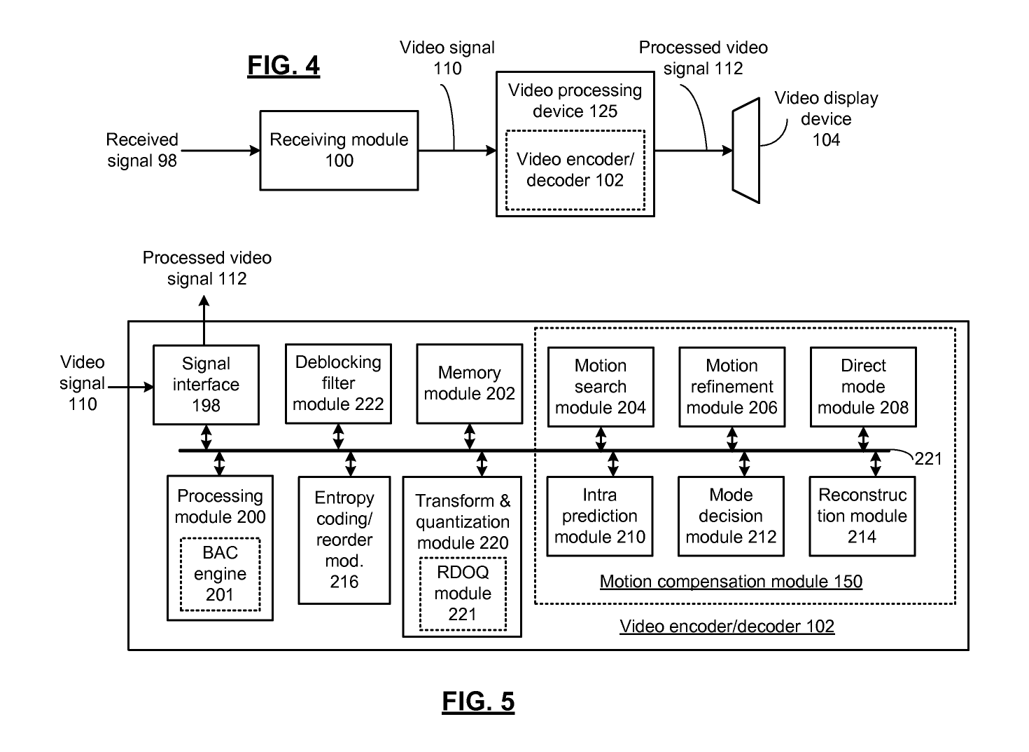

FIGS. 1-3 present pictorial diagram representations of a various video processing devices in accordance with embodiments of the present disclosure. In particular, set top box 10 with built-in digital video recorder functionality or a stand alone digital video recorder, computer 20 and portable computing device 30 illustrate electronic devices that incorporate a video processing device 125 that includes one or more features or functions of the present disclosure. While these particular devices are illustrated, video processing device 125 includes a tablet, smartphone, streaming media player and/or any other device that is capable of encoding, decoding and/or transcoding video content in accordance with the methods and systems described in conjunction with FIGS. 4-13 and the appended claims.

FIG. 4 presents a block diagram representation of a video processing device 125 in accordance with an embodiment of the present disclosure. In particular, video processing device 125 includes a receiving module 100, such as a television receiver, cable television receiver, satellite broadcast receiver, broadband modem, 3G, 4G or 5G transceiver or other information receiver or transceiver that is capable of receiving a received signal 98 and extracting one or more video signals 110 via time division demultiplexing, frequency division demultiplexing or other demultiplexing technique. Video encoder/decoder 102 is coupled to the receiving module 100 to encode, decoder and/or transcode the video signal 110 in a format corresponding to video display device 104.

In an embodiment of the present disclosure, the received signal 98 is a broadcast video signal, such as a television signal, high definition television signal, enhanced high definition television signal or other broadcast video signal that has been transmitted over a wireless medium, either directly or through one or more satellites or other relay stations or through a cable network, optical network or other transmission network. In addition, received signal 98 can be generated from a stored video file, played back from a recording medium such as a magnetic tape, magnetic disk or optical disk, and can include a streaming video signal that is transmitted over a public or private network such as a local area network, wide area network, metropolitan area network or the Internet.

Video signal 110 can include an analog video signal that is formatted in any of a number of video formats including National Television Systems Committee (NTSC), Phase Alternating Line (PAL) or Sequentiel Couleur Avec Memoire (SECAM). Video signal 110 and processed video signal includes 112 a digital video codec standard such as H.264, H.265 MPEG-4 Part 10 Advanced Video Coding (AVC) or other digital format such as a Motion Picture Experts Group (MPEG) format (such as MPEG1, MPEG2 or MPEG4), Quicktime format, Real Media format, Windows Media Video (WMV) or Audio Video Interleave (AVI), S-Video, digital visual interface (DVI), high-definition multimedia interface (HDMI) or another digital video format, either standard or proprietary.

Video display devices 104 can include a television, monitor, computer, handheld device or other video display device that creates an optical image stream either directly or indirectly, such as by projection, based on decoding the processed video signal 112 either as a streaming video signal or by playback of a stored digital video file. It is noted that the present disclosure can also be implemented by transcoding a video stream and storing it or decoding a video stream and storing it, for example, for later playback on a video display device.

Video encoder/decoder 102 includes a binary arithmetic coding engine and/or rate distortion optimizing quantization module that operates in accordance with the present disclosure and, in particular, includes many optional functions and features described in conjunction with FIGS. 5-13 that follow.

FIG. 5 presents a block diagram representation of a video encoder/decoder 102 in accordance with an embodiment of the present disclosure. Video encoder/decoder 102 can be a video codec that operates in accordance with many of the functions and features of the H.264 or H.265 standard, the MPEG-4 standard, VC-1 (SMPTE standard 421M) or other standard, to process processed video signal 112 to encode, decode or transcode video input signal 110. Video input signal 110 is optionally formatted by signal interface 198 for encoding, decoding or transcoding by video encoder/decoder 102. In particular, video encoder/decoder 102 includes a processing module 200 with a BAC engine 201 and a transform and quantization module 220 with a rate distortion optimized quantization (RDOQ) module 221.

The video encoder/decoder 102 includes a processing module 200 that can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 202. Memory module 202 may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module 200 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

Processing module 200, and memory module 202 are coupled, via bus 221, to the signal interface 198 and a plurality of other modules, such as motion search module 204, motion refinement module 206, direct mode module 208, intra-prediction module 210, mode decision module 212, reconstruction module 214, entropy coding/reorder module 216, forward transform and quantization module 220 and deblocking filter module 222. The modules of video encoder/decoder 102 can be implemented in software, firmware or hardware, depending on the particular implementation of processing module 200. It should also be noted that the software implementations of the present disclosure can be stored on a tangible storage medium such as a magnetic or optical disk, read-only memory or random access memory and also be produced as an article of manufacture. While a particular bus architecture is shown, alternative architectures using direct connectivity between one or more modules and/or additional busses can likewise be implemented in accordance with the present disclosure.

Video encoder/decoder 102 can operate in various modes of operation that include an encoding mode and a decoding mode that is set by the value of a mode selection signal that may be a user defined parameter, user input, register value, memory value or other signal. In addition, in video encoder/decoder 102, the particular standard used by the encoding or decoding mode to encode or decode the input signal can be determined by a standard selection signal that also may be a user defined parameter, user input, register value, memory value or other signal. In an embodiment of the present disclosure, the operation of the encoding mode utilizes a plurality of modules that each perform a specific encoding function. The operation of decoding can also utilize at least one of these plurality of modules to perform a similar function in decoding. In this fashion, modules such as the motion refinement module 206, direct mode module 208, and intra-prediction module 210, mode decision module 212, reconstruction module 214, transformation and quantization module 220, and deblocking filter module 222, can be used in both the encoding and decoding process to save on architectural real estate when video encoder/decoder 102 is implemented on an integrated circuit or to achieve other efficiencies.

While not expressly shown, video encoder/decoder 102 can include a comb filter or other video filter, and/or other module to support the encoding of video input signal 110 into processed video signal 112.

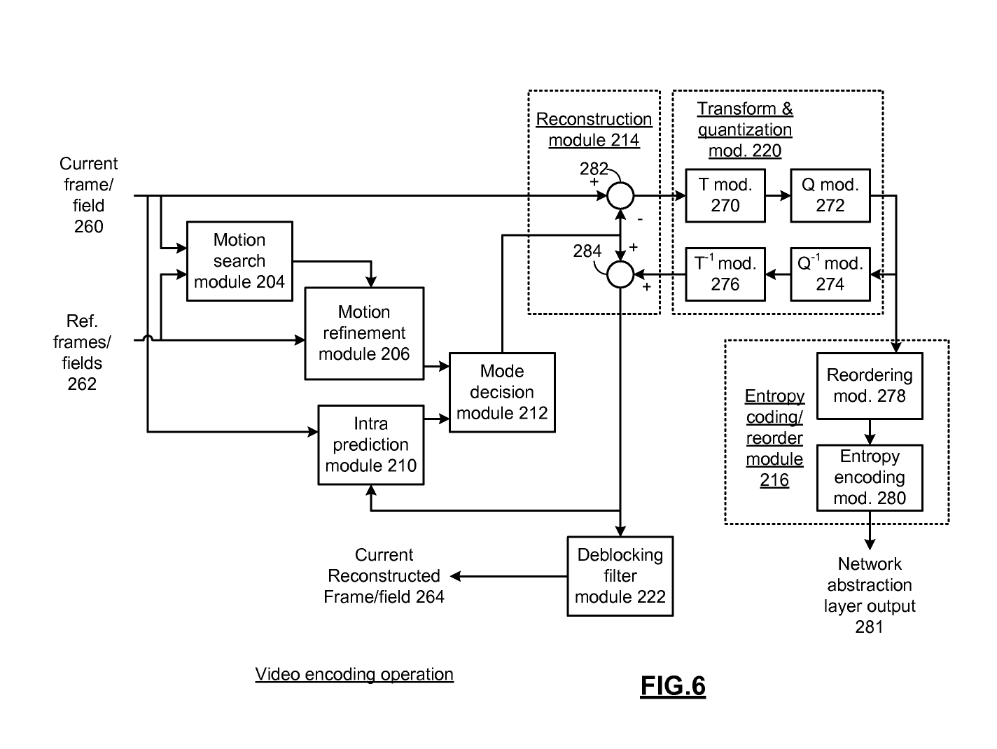

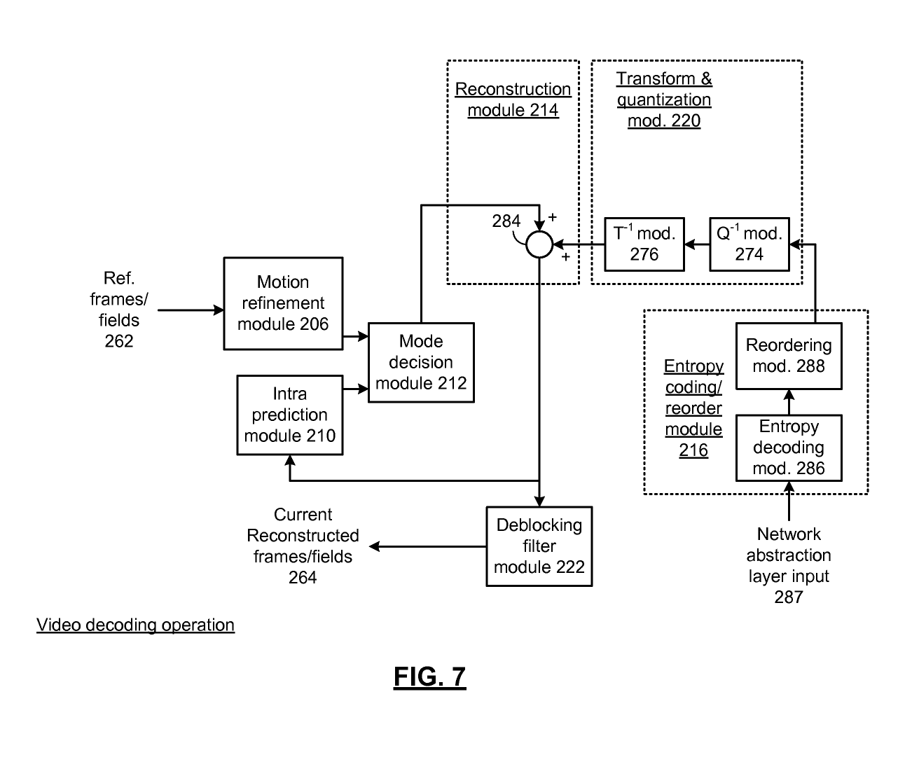

Further details of specific encoding and decoding processes that use these function specific modules will be described in greater detail in conjunction with FIGS. 6 and 7.

FIG. 6 presents a block flow diagram of a video encoding operation in accordance with an embodiment of the present disclosure. In particular, an example video encoding operation is shown that uses many of the function specific modules described in conjunction with FIG. 5 to implement an encoding operation, such as a H.264, H.265 or other encoding. Motion search module 204 generates a motion search motion vector for each macroblock of a plurality of macroblocks based on a current frame/field 260 and one or more reference frames/fields 262. Motion refinement module 206 generates a refined motion vector for each macroblock of the plurality of macroblocks, based on the motion search motion vector. Intra-prediction module 210 evaluates and chooses a best intra prediction mode for each macroblock of the plurality of macroblocks. Mode decision module 212 determines a final motion vector for each macroblock of the plurality of macroblocks based on costs associated with the refined motion vector, and the best intra prediction mode.

Reconstruction module 214 generates residual pixel values corresponding to the final motion vector for each macroblock of the plurality of macroblocks by subtraction from the pixel values of the current frame/field 260 by difference circuit 282 and generates unfiltered reconstructed frames/fields by re-adding residual pixel values (processed through transform and quantization module 220) using adding circuit 284. The transform and quantization module 220 transforms and quantizes the residual pixel values in transform module 270 and quantization module 272 and re-forms residual pixel values by inverse transforming and dequantization in inverse transform module 276 and dequantization module 274. In addition, the quantized and transformed residual pixel values are reordered by reordering module 278 and entropy encoded by entropy encoding module 280 of entropy coding/reordering module 216 to form network abstraction layer output 281.

Deblocking filter module 222 forms the current reconstructed frames/fields 264 from the unfiltered reconstructed frames/fields. While a deblocking filter is shown, other filter modules such as comb filters or other filter configurations can likewise be used within the broad scope of the present disclosure. It should also be noted that current reconstructed frames/fields 264 can be buffered to generate reference frames/fields 262 for future current frames/fields 260.

As discussed in conjunction with FIG. 5, one of more of the modules described herein can also be used in the decoding process as will be described further in conjunction with FIG. 7.

FIG. 7 presents a block flow diagram of a video decoding operation in accordance with an embodiment of the present disclosure. In particular, this video decoding operation contains many common elements described in conjunction with FIG. 6 that are referred to by common reference numerals and can be used to decode in conjunction with H.264, H.265 or other encoding. In this case, the motion refinement module 206, the intra-prediction module 210, the mode decision module 212, and the deblocking filter module 222 are each used as described in conjunction with FIG. 6 to process reference frames/fields 262. In addition, the reconstruction module 214 reuses the adding circuit 284 and the transform and quantization module reuses the inverse transform module 276 and the inverse quantization module 274. In should be noted that while entropy coding/reorder module 216 is reused, instead of reordering module 278 and entropy encoding module 280 producing the network abstraction layer output 281, network abstraction layer input 287 is processed by entropy decoding module 286, such as entropy decoding module 75, and reordering module 288.

While the reuse of modules, such as particular function specific hardware engines, has been described in conjunction with the specific encoding and decoding operations of FIGS. 6 and 7, the present disclosure can likewise be similarly employed to the other embodiments of the present disclosure and/or with other function specific modules used in conjunction with video encoding and decoding.

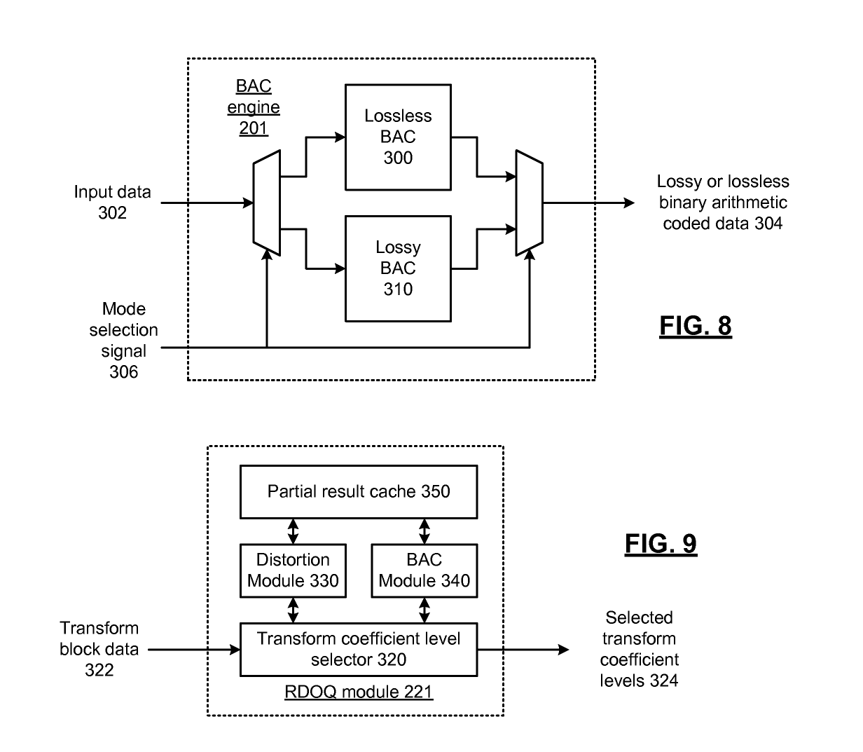

FIG. 8 presents a block diagram representation of a binary arithmetic coding engine 201 in accordance with an embodiment of the present disclosure. As discussed above, Binary arithmetic coding (BAC) is a type of coding included in H.264, H.265 and other video encoding standards. While BAC is only a small part of encoding and decoding, BAC processing can have a great effect on processing time due to the large number of times BAC calculations are performed in processing a single picture. In particular, BAC calculations can be used in cost calculations in the determination of motion vectors for motion compensation; the determination of a reference index for multi-frame motion-compensated prediction; the determination of an intra-prediction mode, a determination of macroblock or sub-macroblock coding mode; the determination of transform coefficient levels, etc. In addition, BAC calculations can be used in entropy coding such as in context adaptive BAC (CABAC) coding or context adaptive variable length coding (CAVLC) or other entropy coding operations.

The binary arithmetic coding engine 201 can be included in processing module 200 and for use by transform and quantization module 220, entropy coding/reorder module 216 and/or the various modules of motion compensation module 150. The BAC engine 201 includes a lossy binary arithmetic coding module 310 configured to process input data 302 into lossy binary arithmetic coded data 304 when the mode selection signal indicates a first mode of operation 306. In this mode of operation, the lossy binary arithmetic coded data 304 merely approximates a lossless binary arithmetic coding of the input data 302. However, high accuracy is not required when the BAC engine 201 is being used merely for cost calculations in the determination of motion vectors for motion compensation; the determination of a reference index for multi-frame motion-compensated prediction; the determination of an intra-prediction mode, a determination of macroblock or sub-macroblock coding mode; and/or the determination of transform coefficient levels. Some inaccuracy or loss of resolution can be tolerated because the end result may be only that a slightly less optimal motion vector, transform quantization level, intra-prediction mode, macroblock partition, reference index, or mode decision is selected. In an embodiment, the lossy BAC 210 uses reduced resolution arithmetic calculations, in a standard arithmetic-based BAC coding. In other examples, a probability-ratio approach, a quasi-arithmetic coder other BAC approximation methodologies are used that generate an estimate of the true binary arithmetic coding or cost associated with input data 302.

The BAC engine 201 further includes a lossless binary arithmetic coding module 300 configured to process the input data 302 into lossless binary arithmetic coded data 304 when the mode selection signal 306 indicates a second mode of operation, such as when accurate coding is required in association with an entropy encoding operation.

As shown a demultiplexer is configured to selectively route the input data 302 to the lossy binary arithmetic coding module 310 when the mode selection signal 306 indicates the first mode of operation, and further to selectively route the input data 302 to the lossless binary arithmetic coding module 300 when the mode selection signal 306 indicates the second mode of operation. A multiplexer is configured to selectively route the lossy binary arithmetic coded data 304 from the lossy binary arithmetic coding module 310 when the mode selection signal 306 indicates the first mode of operation, and further to selectively route the lossless binary arithmetic coded data 304 from the lossless binary arithmetic coding module 300 when the mode selection signal 306 indicates the second mode of operation.

In an embodiment, the video encoder/decoder 102 generates the mode selection signal 306 by determining the action being performed, indicating the first mode of operation when the action being performed a cost calculations in the determination of motion vectors for motion compensation; the determination of a reference index for multi-frame motion-compensated prediction; the determination of an intra-prediction mode, a determination of macroblock or sub-macroblock coding mode; the determination of transform coefficient levels or other cost calculation or circumstance where different options are being evaluated for decision purposes. The video encoder/decoder 102 generates the mode selection signal 306 to indicate the second mode of operation when the action being performed corresponds to BAC calculations used in entropy coding such as in context adaptive BAC (CABAC) coding or context adaptive variable length coding (CAVLC) or other entropy coding operations.

The lossless BAC module 300 and lossy BAC module 310 can be implemented via a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing device may further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information.

FIG. 9 presents a block diagram representation of a rate distortion optimized quantization module 221 in accordance with an embodiment of the present disclosure. In particular, RDOQ module 221 is presented as part of transform and quantization module 220 to select transform coefficient levels 324 from transform block data 322. Considering the vector of transform coefficient levels to be represented by l, rate distortion optimized quantization can be represented by finding or approximating:

l*=argminD(l)+λR(l)

over the vector space of N transform coefficient levels and where D(l) represents the distortion and R(l) represents the bits associated with a particular selection l and based on the transform block data 322 and where λ represents the Lagrange multiplier. For the transform block data 322 and a particular selection l, the distortion module 330 determines the term D(l) as distortion data and the binary arithmetic coding (BAC) module determines R(l) as BAC data.

The transform coefficient level selector 320 selects the transform coefficient levels 324, by evaluating a plurality of candidate transform coefficient levels based on distortion data from the distortion module 330 and BAC data from the BAC module 340. The distortion module 330 and the BAC module 340 store a plurality of partial results in a partial result cache 350 in conjunction with processing ones of the plurality of candidate transform coefficient levels. The distortion module 330 and the BAC module 340 reuse the plurality of partial results from the partial result cache 350 in conjunction with processing of subsequent ones of the plurality of candidate transform coefficient levels. As used herein partial results include results for either distortion data or BAC data for a portion or (a proper subset) of the full block transform data 322, such as data corresponding to only a part of a matrix of transform coefficients or other partial data set or intermediate results in the calculation of either distortion data or BAC data.

In an embodiment, the distortion module 330 operates in conjunction with transform coefficient selector 320 to evaluate candidate transform coefficient levels based on the transform block data 322. As the distortion for different candidate transform coefficient levels are evaluated, the distortion module 330 selects partial results for storage in the partial result cache 350 based on a determination that partial results differs from other partial results previously stored in the partial result cache 350. New partial results that are unique and have not been previously stored can be saved. The distortion module 330 selects partial results for reuse in conjunction with the evaluation of subsequent candidate transform coefficient levels, when the one of the plurality of partial results match with corresponding portion of these subsequent candidate transform coefficient levels. In this fashion, partial results determined in the processing of the first m−1 candidate transform coefficient levels can be used in evaluating distortion for the mth and subsequent candidate transform coefficient levels, potentially reducing the number of distortion calculations. The partial result cache 350 can be flushed with the processing of each new transform block, more frequently if a large number of partial results accumulate or some partial results are not being reused or less frequently if partial results for one transform block can be reused in other transform blocks.

In a similar fashion, the BAC module 340 operates in conjunction with transform coefficient selector 320 to evaluate candidate transform coefficient levels based on the transform block data 322. As the cost for different candidate transform coefficient levels are evaluated, the BAC module 340 selects partial results for storage in the partial result cache 350 based on a determination that partial results differs from other partial results previously stored in the partial result cache 350. New partial results that are unique and have not been previously stored can be saved. The BAC module 340 selects partial results for reuse in conjunction with the evaluation of subsequent candidate transform coefficient levels, when the one of the plurality of partial results match with corresponding portion of these subsequent candidate transform coefficient levels. In this fashion, partial results determined in the processing of the first m−1 candidate transform coefficient levels can be used in evaluating the cost for the mth and subsequent candidate transform coefficient levels, potentially reducing the number of BAC calculations.

In addition, to directly reusing partial results, the transform coefficient level selector 320 is operable to eliminate a subset of subsequent candidate transform coefficient levels from the evaluation based on the reuse of the partial results from the partial result cache. Partial results that by themselves indicate either a higher distortion or higher cost that would make it unlikely that a particular candidate would be ultimately selected as the optimum, can indicate that evaluation of the candidate can be skipped. In this fashion, the RDOQ module 321 can greatly reduce the number of calculations required to arrive at the selected transform coefficient levels 324.

In an embodiment, the BAC module 340 can be implemented via BAC engine 201 with the mode selection signal 306 indicating lossy BAC processing, however other BAC processing could likewise be used. The distortion module 330 and transform coefficient level selector 320 can be implemented via a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The partial result cache 350 can be implemented via a memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. The processing device used in implementing the distortion module 330 and transform coefficient level selector 320 may further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information.

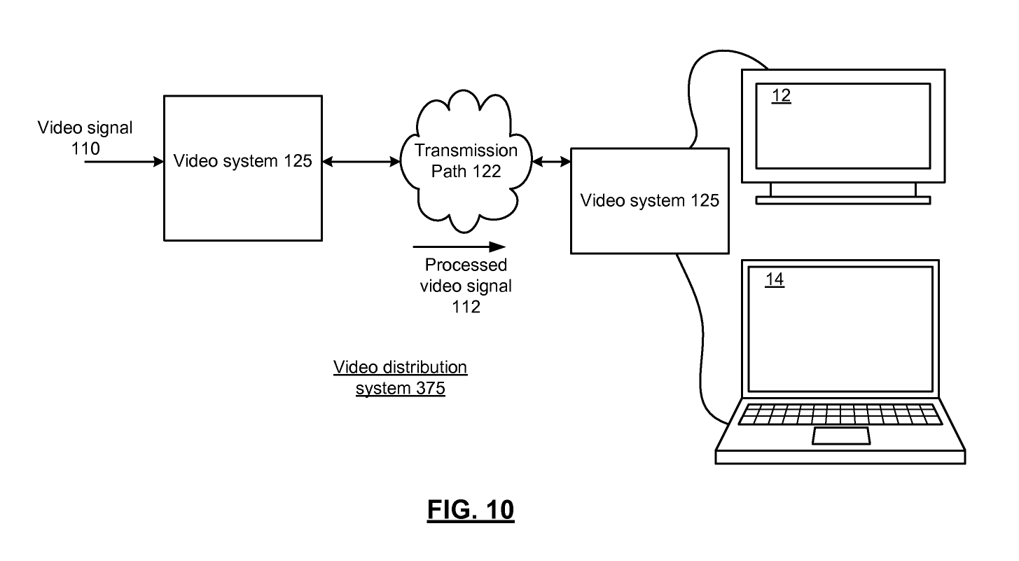

FIG. 10 presents a block diagram representation of a video distribution system 375 in accordance with an embodiment of the present disclosure. In particular, processed video signal 112 is transmitted from a first video system 125 via a transmission path 122 to a second video system 125 that operates as a decoder. The second video system 125 operates to decode the processed video signal 112 for display on a display device such as television 10, computer 20 or other display device.

The transmission path 122 can include a wireless path that operates in accordance with a wireless local area network protocol such as an 802.11 protocol, a WIMAX protocol, a Bluetooth protocol, etc. Further, the transmission path can include a wired path that operates in accordance with a wired protocol such as a Universal Serial Bus protocol, an Ethernet protocol or other high speed protocol.

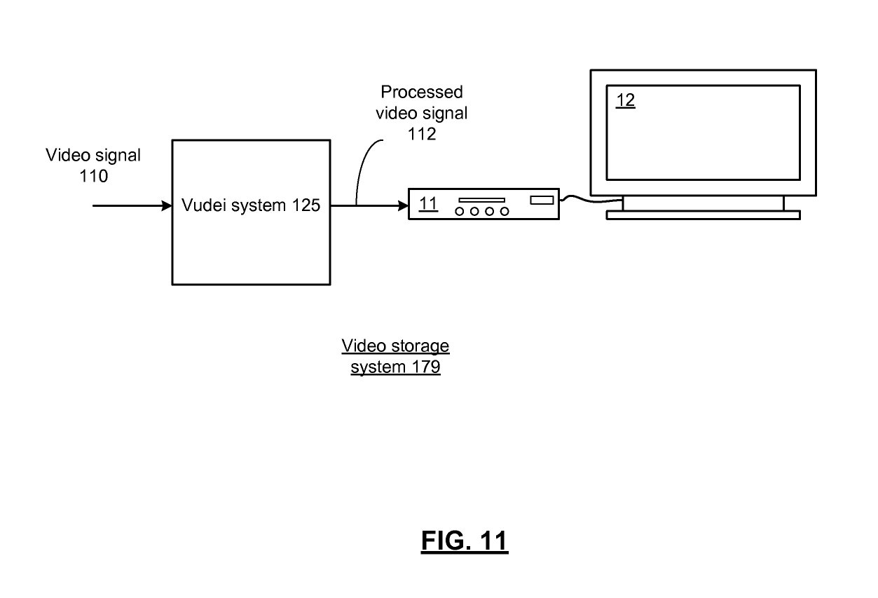

FIG. 11 presents a block diagram representation of a video storage system 179 in accordance with an embodiment of the present disclosure. In particular, device 11 is a set top box with built-in digital video recorder functionality, a stand alone digital video recorder, a DVD recorder/player or other device that stores the processed video signal 112 for display on video display device such as television 12. While video system 125 is shown as a separate device, it can further be incorporated into device 11. In this configuration, video system 125 can further operate to decode the processed video signal 112 when retrieved from storage to generate a video signal in a format that is suitable for display by video display device 12. While these particular devices are illustrated, video storage system 179 can include a hard drive, flash memory device, computer, DVD burner, or any other device that is capable of generating, storing, decoding and/or displaying the video content of processed video signal 112 in accordance with the methods and systems described in conjunction with the features and functions of the present disclosure as described herein.

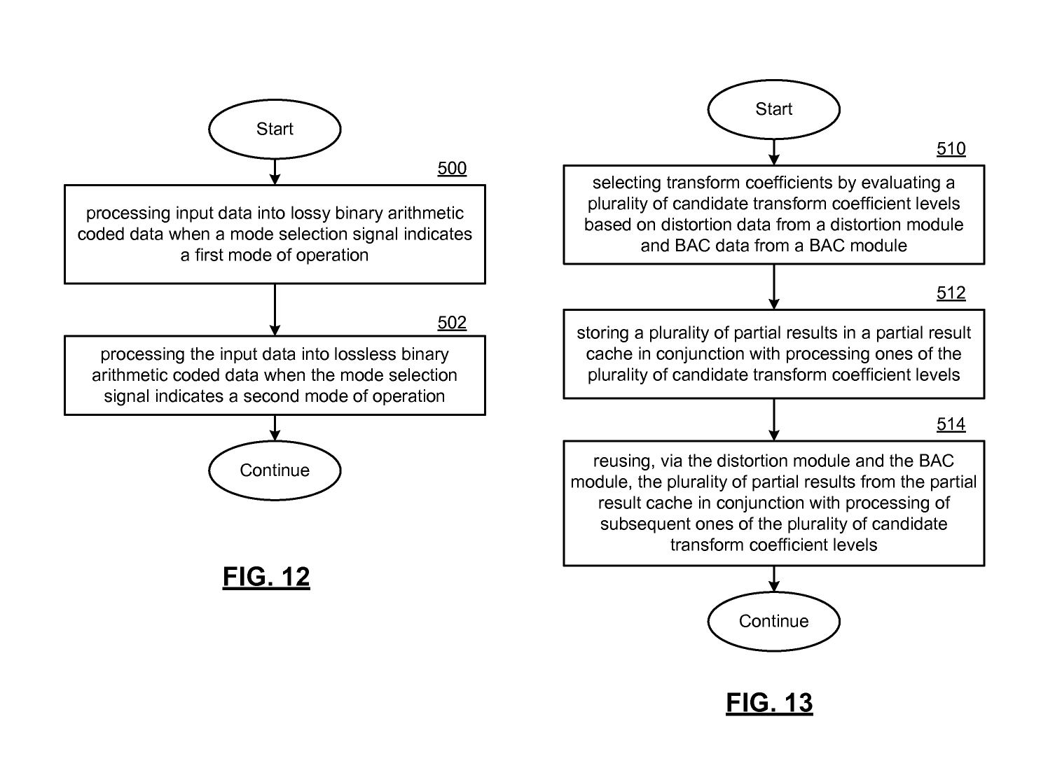

FIG. 12 presents a flowchart representation of a method in accordance with an embodiment of the present disclosure. In particular, a method is presented for use in conjunction with one or more of the features and functions described in association with FIGS. 1-11. Step 500 includes processing input data into lossy binary arithmetic coded data when a mode selection signal indicates a first mode of operation. Step 502 includes processing the input data into lossless binary arithmetic coded data when the mode selection signal indicates a second mode of operation.

In an embodiment, the method further includes generating the mode selection signal to indicate the second mode of operation in association with an entropy encoding operation and generating the mode selection signal to indicate the first mode of operation in association with at least one of: a determination of motion vectors for motion compensation; a determination of a reference index for multi-frame motion-compensated prediction; a determination of an intra-prediction mode, a determination of macroblock or sub-macroblock coding mode; or a determination of transform coefficient levels. The lossy binary arithmetic coded data can approximate a lossless binary arithmetic coding of the input data.

FIG. 13 presents a flowchart representation of a method in accordance with an embodiment of the present disclosure. In particular, a method is presented for use in conjunction with one or more of the features and functions described in association with FIGS. 1-12. Step 510 includes selecting transform coefficient levels by evaluating a plurality of candidate transform coefficient levels based on distortion data from a distortion module and BAC data from a BAC module. Step 512 includes storing a plurality of partial results in a partial result cache in conjunction with processing ones of the plurality of candidate transform coefficient levels. Step 514 includes reusing, via the distortion module and the BAC module, the plurality of partial results from the partial result cache in conjunction with processing of subsequent ones of the plurality of candidate transform coefficient levels.

In an embodiment, the method further comprises eliminating a subset of the subsequent ones of the plurality of candidate transform coefficient levels from the evaluation based on the reuse of the partial results from the partial result cache. The method can include selecting, via the distortion module, one of the plurality of partial results for storage in the partial result cache based on a determination that that the one of the plurality of partial results differs from the other ones of the plurality of partial results stored in the partial result cache. The method can include selecting, via the BAC module, one of the plurality of partial results for storage in the partial result cache based on a determination that that the one of the plurality of partial results differs from the other ones of the plurality of partial results stored in the partial result cache. The method can include selecting, via the distortion module, one of the plurality of partial results for reuse in conjunction with processing of the subsequent ones of the plurality of candidate transform coefficient levels, when the one of the plurality of partial results match with a portion of the subsequent ones of the plurality of candidate transform coefficient levels. The method can include selecting, via the BAC module, one of the plurality of partial results for reuse in conjunction with processing of the subsequent ones of the plurality of candidate transform coefficient levels, when the one of the plurality of partial results match with a portion of the subsequent ones of the plurality of candidate transform coefficient levels.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A binary arithmetic coding engine for use in a video coder that processes a video input signal, the binary arithmetic coding engine comprising:
a lossy binary arithmetic coding module configured to process input data into lossy binary arithmetic coded data when a mode selection signal indicates a first mode of operation; and
a lossless binary arithmetic coding module configured to process the input data into lossless binary arithmetic coded data when the mode selection signal indicates a second mode of operation.

2. The binary arithmetic coding engine of claim 1 wherein the video coder generates the mode selection signal to indicate the second mode of operation in association with an entropy encoding operation.

3. The binary arithmetic coding engine of claim 1 wherein the video coder generates the mode selection signal to indicate the first mode of operation in association with at least one of: a determination of motion vectors for motion compensation; a determination of a reference index for multi-frame motion-compensated prediction; a determination of an intra-prediction mode; a determination of macroblock or sub-macroblock coding mode; or a determination of transform coefficient levels.

4. The binary arithmetic coding engine of claim 1 wherein the lossy binary arithmetic coded data approximates a lossless binary arithmetic coding of the input data.

5. The binary arithmetic coding engine of claim 1 further comprising:
a demultiplexer configured to selectively route the input data to the lossy binary arithmetic coding module when the mode selection signal indicates the first mode of operation, and further to selectively route the input data to the lossless binary arithmetic coding module when the mode selection signal indicates the second mode of operation.

6. The binary arithmetic coding engine of claim 1 further comprising:
a multiplexer configured to selectively route the lossy binary arithmetic coded data from the lossy binary arithmetic coding module when the mode selection signal indicates the first mode of operation, and further to selectively route the lossless binary arithmetic coded data from the lossless binary arithmetic coding module when the mode selection signal indicates the second mode of operation.

7. A method for use in a video coder that processes a video input signal, the method comprising:
processing input data into lossy binary arithmetic coded data when a mode selection signal indicates a first mode of operation; and
processing the input data into lossless binary arithmetic coded data when the mode selection signal indicates a second mode of operation.

8. The method of claim 7 further comprising:
generating the mode selection signal to indicate the second mode of operation in association with an entropy encoding operation.

9. The method of claim 7 further comprising:
generating the mode selection signal to indicate the first mode of operation in association with at least one of: a determination of motion vectors for motion compensation; a determination of a reference index for multi-frame motion-compensated prediction; a determination of an intra-prediction mode; a determination of macroblock or sub-macroblock coding mode; or a determination of transform coefficient levels.

10. The method of claim 7 wherein the lossy binary arithmetic coded data approximates a lossless binary arithmetic coding of the input data.
